(19) United States
(12) Patent Application Publication
(10) Pub. No.: US 2003/0189353 A1
(43) Pub. Date: Oct. 9, 2003

(54) Truck Mounted Toolbox Bracket Assembly

(76) Inventor: Thomas R. Moore, Reddick, FL (US)

Correspondence Address: RYAN KROMHOLZ & MANION, S.C., POST OFFICE BOX 26618, MILWAUKEE, WI, 53226, US

(21) Appl. No.: 10/249,066

(22) Filed: Mar. 13, 2003

Related U.S. Application Data
(60) Provisional application No. 60/370,481, filed on Apr. 5, 2002.

(51) Int. Cl. B60N 3/12

(52) U.S. Cl. 296/37.6

(57) ABSTRACT

A multiple-part hinged bracket assembly for pivotally supporting a toolbox or other container in a slightly elevated position towards the rear of the truck bed, abutting the tailgate. The elevated position allows the full truck bed area to be utilized when hauling large dimensional sheets of material. The toolbox or container is accessible from the rear of the truck in its stored position or outside the truck in the deployed position. The bracket assembly may include a brace that allows the toolbox to be deployed and secured in a preselected pivotal position.

### RELATED APPLICATION

This application claims the benefit of provisional application Serial No. 60/370,481, filed Apr. 5, 2002.

### BACKGROUND OF INVENTION

The present invention relates to truck-mounted toolboxes, and more specifically to a mounting bracket therefore. Toolboxes typically mount to the truck bed, or to the sidewalls of the truck, directly behind the passenger area. Some designs utilize a T-shaped cross section that allows the upper lip on either side of the toolbox to extend over the width of the truck sidewalls, while others employ standard rectangular shapes and mount directly to the truck bed.

Prior art toolboxes have a number of drawbacks. First, access to tools can be difficult. Because a T-shaped toolbox may extend a number of inches above the highest point of the truck sidewall, a person outside of the vehicle must reach quite high to access tools contained therein. For shorter people, vision into the toolbox can be blocked. Additionally, most users cannot reach into the central portion of the toolbox from outside the vehicle, and must climb into the truck bed to do so. Smaller rectangular boxes, when mounted behind the cab, suffer similar access difficulty. Conversely, if the toolbox is mounted near the rear of the truck bed to allow easier access, the toolbox hinders access to the remaining available cargo area.

Other drawbacks to conventional toolboxes include other limitations on the utility of the truck. Many truck beds are sized according to standardization in various industries. For example, many are dimensioned just large enough to accommodate standard 4′×8′ dimensional sheets of material (such as plywood or drywall) lying flat in the bed, while still allowing closure of the tailgate. Toolboxes that mount to the truck bed negate this capability. Additionally, toolboxes that are taller than the truck sidewalls cut into the rearward view of the driver. And because many toolboxes are manufactured using shiny metals, the visible areas that extend above the sidewalls reflect light and can blind other motorists.

For instance, Smith (U.S. Pat. No. 4,564,167) suggests a pivoting toolbox mounting assembly that is located near the rear of a vehicle. However, Smith does not have a support frame for handling toolboxes that would extend across the entire width of a vehicle bed. Furthermore, when swung outwardly from the vehicle bed, the toolbox prevents access to the vehicle bed.

### SUMMARY OF INVENTION

The present invention comprises a two-part bracket assembly for pivotally supporting a toolbox in a slightly elevated position towards the rear of the truck bed, abutting the tailgate. The elevated position allows the full truck bed area to be utilized when hauling several 4′×8′ dimensional sheets of material. Depending upon the style of toolbox installed in the bracket, the location of the bracket may provide added security by preventing the toolbox from being opened when the tailgate is latched and locked.

The bracket assembly comprises a U-shaped frame having a hinge structure located on one upstanding arm of the frame and a latch structure on the opposing side. A toolbox support frame is hingedly attached to an upstanding arm of the U-shaped frame. A locking mechanism located on the support frame interacts with the latch structure to secure the toolbox in a closed position. The bracket assembly allows the toolbox to swing out of the truck bed about a vertical axis. Thus, a person may easily access all areas of the toolbox comfortably from the back of the truck and from outside the truck. The toolbox mobility also allows the toolbox to move out of the way during loading and unloading of cargo.

In an alternate embodiment of the invention, a support plate is attached with a hinge to the U-shaped frame at a proximal end. The distal end of the support plate is hingedly attached to another support plate. An additional latching mechanism may be provided between the first support plate and the toolbox support frame. When latched, the toolbox support frame can pivot about the vertical axis at one side of the U-shaped frame. When unlatched, the toolbox support frame can pivot relative to the first support plate and pivot relative to the U-shaped frame. This allows two degrees of motion. For ease of movement, a handle may be attached to the upstanding portion of the toolbox support frame.

Another feature of the present invention is a brace that allows the toolbox to be securely held in place when the toolbox is swung out from the vehicle bed. This allows access to the vehicle bed without concern for the toolbox swinging back towards the vehicle bed.

One of the benefits of the present design resides in the U-shaped frame. The frame may be attached to the bed of the pickup truck with fasteners, such as carriage bolts, or any other conventional means. The frame adds strength and rigidity to the truck bed, thereby allowing a heavy load within the toolbox to be evenly distributed along the back of the truck.

### BRIEF DESCRIPTION OF DRAWINGS

FIG. 1 is a rear fragmentary perspective view of a truck including the toolbox support frame supporting a toolbox in the closed position.

FIG. 2 is a rear fragmentary perspective view of the truck showing the toolbox support frame and toolbox deployed outwardly of the bed of the truck.

FIG. 3 is an exploded view of the toolbox support frame and of a typical toolbox supported thereby.

FIG. 4 is a fragmentary view of a brace used to secure the toolbox support frame when the frame has been deployed to a selected position.

FIG. 5 is a fragmentary perspective view showing the brace of FIG. 4 interacting with the support frame.

FIG. 6 is a rear fragmentary perspective view of the latching assembly of the support frame.

FIG. 7 is a front fragmentary perspective view of the latching assembly of the support frame.

FIG. 8 is a fragmentary perspective view of a second embodiment of the current invention and a toolbox to be supported thereby.

FIG. 9 is an exploded view of the second embodiment of the present invention.

FIG. 10 is a fragmentary perspective view of a portion of the hinge assembly of the second embodiment of the present invention.

FIG. 11 is a fragmentary perspective view of the second embodiment in a fully deployed operating position.

### DETAILED DESCRIPTION

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

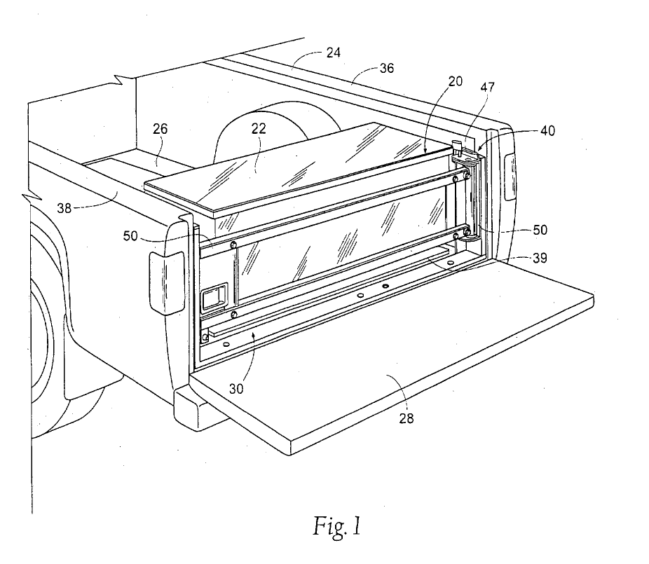

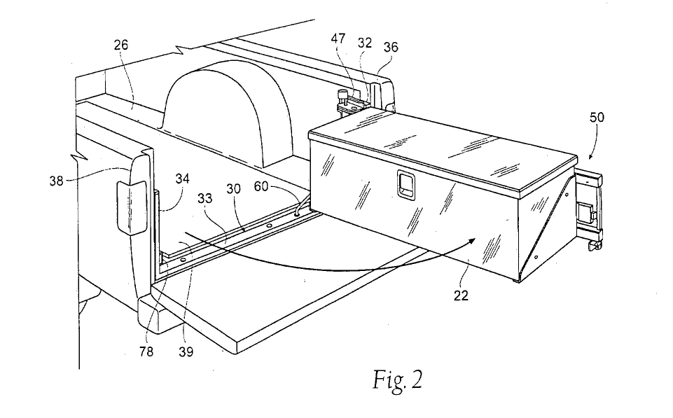

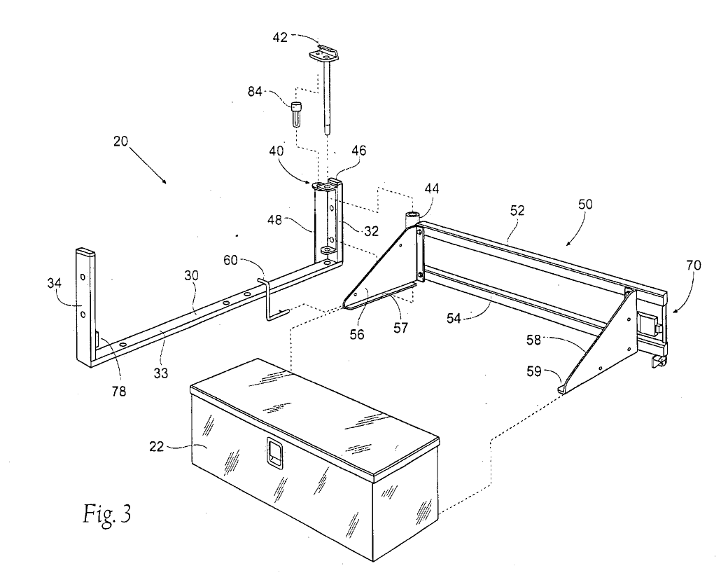

FIG. 1 shows a perspective rear view of a first embodiment of the bracket assembly, generally designated by the numeral 20. The bracket assembly 20 pivotally supports a toolbox 22 at the rear of a vehicle 24. The assembly 20 is preferably assembled to the truck 24 in an elevated position spaced above a vehicle bed 26. The elevated bracket assembly 20 allows access to the vehicle bed 26 even when the bracket assembly 20 is in a closed position. A tailgate 28 is shown in the open position, and it will be observed that the bracket assembly 20 will not interfere with closing of the tailgate 28. The bracket assembly 20 is comprised of three primary sections: a first hinge plate comprising a U-shaped frame 30, a hinge assembly 40, and a second hinge plate 50. For clarity in the specification, the first hinge plate will be referred to as the U-shaped frame 30, and the second hinge plate will be referenced as the hinge plate 50. Each of these sections will be described in further detail with reference to FIGS. 2 and 3.

FIG. 2 shows a perspective view of the hinge plate 50 and the toolbox 22 swung outwardly from the vehicle bed 26. This allows a better view of the U-shaped frame 30. The U-shaped frame 30 comprises a first upstanding arm 32, a base 33, and a second upstanding arm 34 integral with and projecting upwardly from the base 33. The first upstanding arm 32 is attached to a first sidewall 36 and the second upstanding arm 34 is attached to a second sidewall 38. The U-shaped frame 30 may be attached to the first truck sidewall 36, the second truck sidewall 38, and the vehicle bed 26 by nut and bolt fasteners or by any conventional fastening means (not shown).

As shown in FIGS. 1 and 2, it is possible to access the vehicle bed 26 without moving the bracket assembly 20 from either a locked or a closed position. Thus, if it is desired to haul drywall, plywood, or other sheet material 39, one or several of the sheets 39 may be loaded or removed without interfering with the elevated toolbox 22 and the bracket assembly 20. This is also an added safety measure. Because the sheets of material 39 are usually 4′×8′, they would normally fit in the bed 26 of a pickup truck. A conventionally mounted toolbox would require the drywall 39 to rest upon the opened tailgate 28 when being transported. Since the present invention is elevated above the bed 26, the drywall 39 may be positioned underneath the toolbox 22 and the hinge plate 50, and the tailgate 28 may be shut without interference. This also means less sliding of the sheet material 39 when being transported, thereby lessening the possibility of the sheet material 39 sliding off of the vehicle bed 26 and causing damage to the sheet material 39 or to persons or objects located in the vicinity.

FIG. 3 shows an exploded view of the bracket assembly 20. The U-shaped frame 30 is attached to the hinge assembly 40 at the first upstanding arm 32 (see FIG. 2). The hinge assembly comprises a hinge pin 42, a tubular support 44, and a receiving hole 46. The hinge pin 42 is slid through the receiving hole 46 and the tubular support 44, allowing the hinge plate 50 to be pivotally attached to the U-shaped frame 30. Thus, the hinge plate 50 and the toolbox 22 may be swung outwardly from the U-shaped frame 30 and the vehicle bed 26 (see FIG. 2). The hinge pin 42 allows easy removal of the hinge plate 50 and the toolbox 22, should extra space be needed in the vehicle bed 26. An upper lip 47 is located at the top of the hinge pin to allow a user to easily grasp the hinge pin. The hinge pin 42 may be slightly tapered to assist in insertion and removal. In a preferred embodiment, a stiffening rib 48 is added where the hinge assembly 40 and the upstanding arm 32 of the U-shaped frame 30 are connected to give added support to the bracket assembly 20.

Still referring to FIG. 3, the tubular support 44 is attached to the hinge plate 50. The hinge plate 50 also provides the main support for the toolbox 22. The hinge plate 50 is comprised of a first elongate member 52 and a second elongate member 54 each have a length approximately the width of the truck bed 26. The hinge plate 50 further comprises a first side member 56 and a second side member 58. The two side members 56 and 58 are generally upstanding and are attached to the elongate members 52 and 54 at substantially right angles. The side members 56 and 58 contribute support for the toolbox 22 by means of the inwardly formed base portions 57 and 59. The toolbox 22 rests upon the respective base portions 57 and 59 and may be attached to the side members 56 and 58 in any suitable manner, such as conventional bolt and nut assembly (not shown). Likewise the toolbox 22 may be supported in any suitable manner, including an extended bottom conforming in configuration of the bottom of the toolbox 22 (not shown).

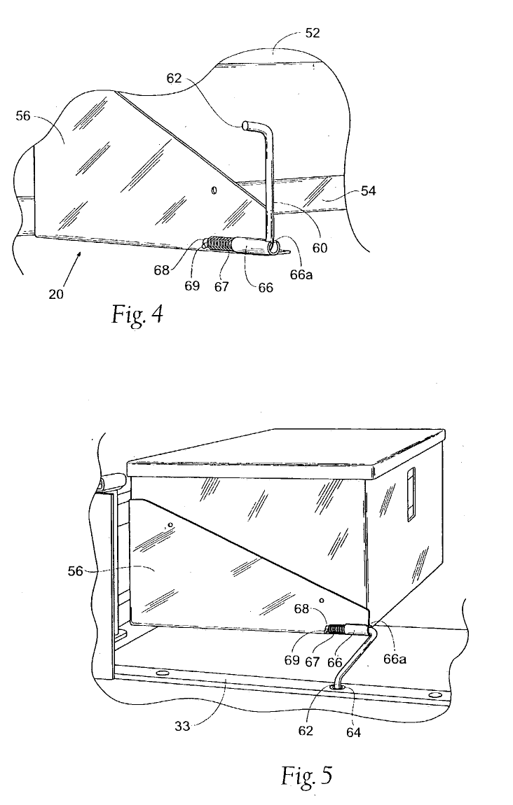

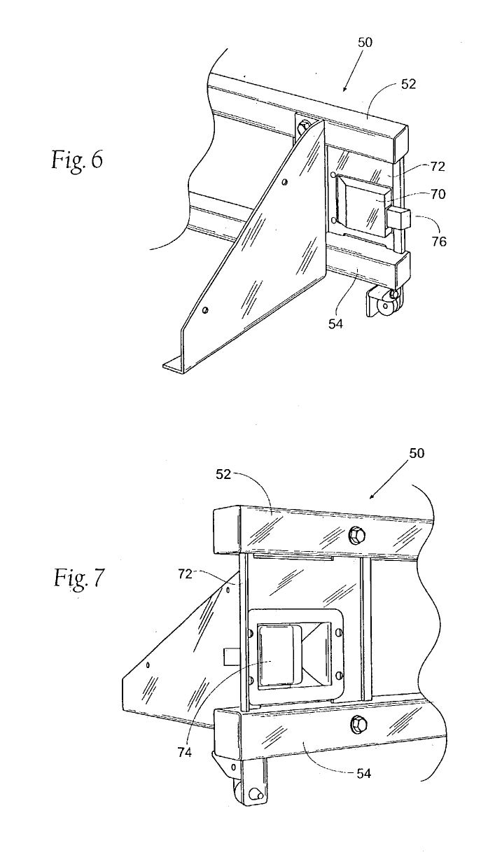

Further referring to FIG. 3 and the hinge plate 50, two other elements are noted. The first element, a bracing rod or support rod 60, is connected to the outside of the first side member 56. The second element, a latching assembly 70, is connected to the hinge plate 50 opposite the hinge assembly 40. The bracing rod 60 and its function will be described in further detail with reference to FIGS. 4 and 5, and the latching assembly 70 will be described in further detail with regard to FIGS. 6 and 7.

FIGS. 4 and 5 show fragmented views of the bracket assembly 20, highlighting the bracing rod 60. The bracing rod 60 is used to secure the toolbox 22 and hinge plate 50 when the hinge plate 50 is in an open position (as shown in FIG. 2). The bracing rod 60 is pivotally attached to the first side member 56 and is received by the bore of the tubular formed tab 66 formed integrally of the side member 56. A slot or notch 66a located in the tab 66 allows the bracing rod to be secured in place when not in use. The bracing rod is formed to provide two approximately ninety-degree (90 ° angles, thereby allowing the rod 60 to provide a male portion 62 arranged for insertion into an aperture 64 formed in the base 33 of the U-shaped frame 30 (see FIG. 5). The tubular formed tab 66 of the side member 56 secures the opposite end 68 of the bracing rod 60. The bracing rod 60 is slid into the bore of the tab 66. The bracing rod 60 is prevented from sliding out of the holding bore 66 by way of a spring 67 and a roll pin 69. When the rod 60 is pivotally moved to cause the male end portion 62 to enter the aperture 64, the hinge plate 50 will be securely held in place, which allows for easy access into the toolbox 22 and prevent the toolbox 22 from moving or swaying. The bracing rod 60 also would be advantageous if used in vehicles, such as SUVs, for holding open the rear doors when accessing the back of the vehicles.

Referring next to FIGS. 6 and 7, the latching assembly 70 is shown in detail. FIG. 6 shows a rear perspective of the latching assembly 70. FIG. 7 shows a front perspective view of the latching assembly 70. The latching assembly 70 comprises a plate 72 located between the first elongate member 52 and the second elongate member 54 of the hinge plate 40. The latching assembly further comprises a handle 74 that will allow a latching dead bolt 76 to be engaged or disengaged with the strike plate 78 secured to the upstanding arm 34 of the U-shaped frame 30. The locking deadbolt 76 allows the latching assembly 70 to interact with the strike plate 78 (see FIGS. 2 and 3), allowing the latching assembly 70 to hold the bracket assembly 20 in a secured, closed position. Overall, the latching assembly 70 may be of any conventional design to securely lock or release the hinge plate 50.

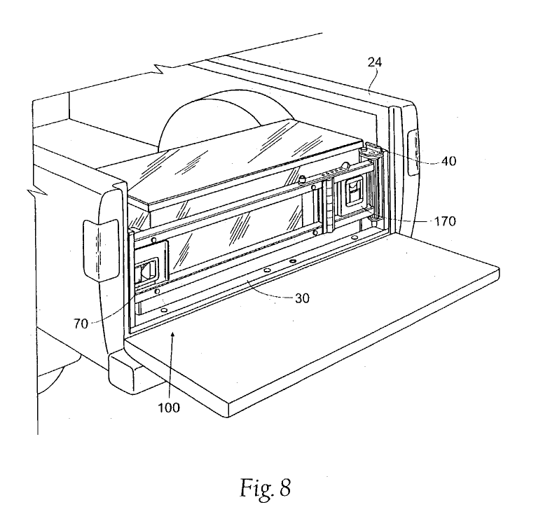

FIGS. 8-11, inclusive, illustrate a second embodiment 100 of the present invention. The second embodiment 100 differs from the first bracket assembly embodiment 20 in that the second embodiment 100 has an additional degree of freedom when swung or deployed outwardly from the vehicle 24. As will be shown, the extra degree of freedom allows the bracket assembly 100 to be swung around to the outside of the first sidewall 36 (see FIG. 11). The U-shaped frame 30, the hinge assembly 40, and a latching assembly 170, are substantially the same as shown in the first embodiment of the bracket assembly 20.

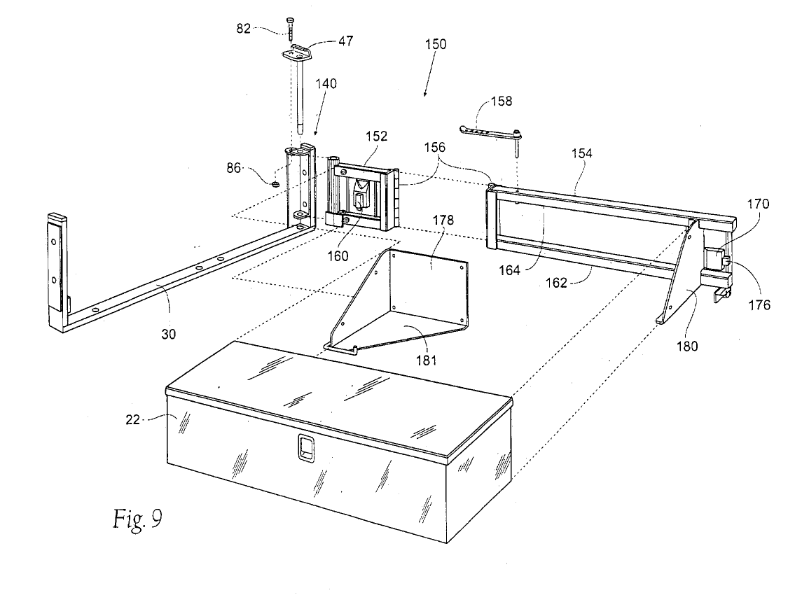

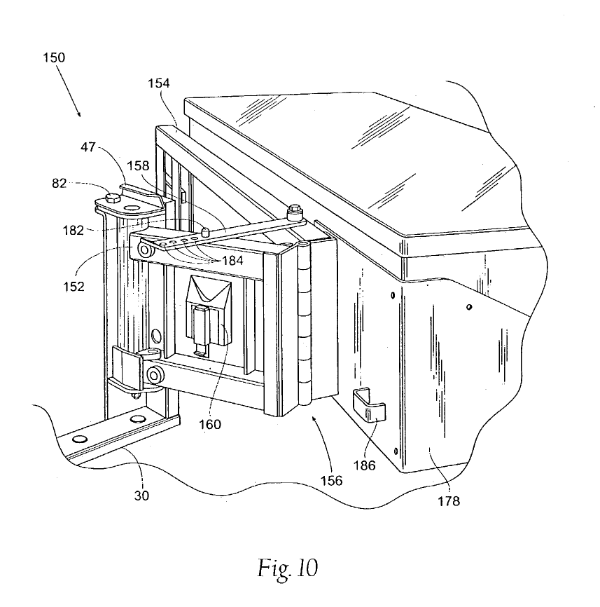

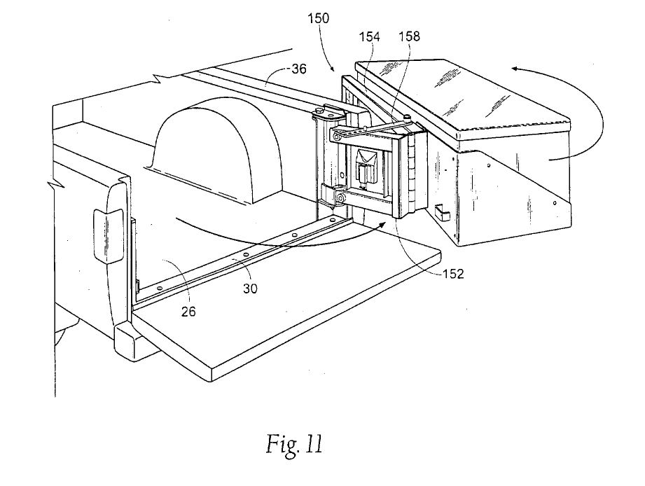

FIG. 9 is an exploded view of the second embodiment 100. A hinge plate 150 consists of a first section (or a second hinge plate) 152 and a second section (or a third hinge plate) 154. The hinge assembly 40 pivotally connects the first section 152 to the U-shaped frame 30. A second locking mechanism 160, located on the first section 152, will be described in further detail with reference to FIG. 10. The first section 152 pivotally connects to the second section 154 by means of a second hinge assembly 156. An adjustable strut 158 attached to the second section 154 also interacts with the first section 152. The second hinge assembly 156 and the strut 158 will be described further in connection with the view of FIG. 10.

Still referring to FIG. 9, the second section 154 forms the bulk of the support frame for the toolbox 22. The second section comprises a first bar 162 and a second bar 164, which are relatively parallel to one another. Located at the end of the second section opposite where the first section 152 and the second section 154 meet, a latching assembly 170 is housed on a plate 176 between the first bar 162 and the second bar 164. The latching assembly 170 is essentially the same as the latching assembly 70 described in the first embodiment above (see FIGS. 6 and 7).

Referring further to FIG. 9, the toolbox 22 is supported by the second section 154. A corner brace 178 attaches the toolbox 22 to the first section 154 near the second hinge assembly 156. A triangular brace 180 attaches the toolbox to the second section 154 near the latching assembly 170. The toolbox 22 may be attached to the braces 178 and 180 in any suitable manner, such as conventional bolt and nut assembly (not shown). A floor 181 formed in the corner brace 178 provides additional support for the toolbox 22. Likewise, as previous mentioned for the first embodiment, the toolbox 22 may be supported in any suitable manner, including an extended bottom conforming in configuration of the bottom of the toolbox 22 (not shown).

FIG. 10 is a fragmentary perspective view detailing the surrounding area of the second hinge assembly 156. The second hinge assembly 156 allows the second section 154 to pivot nearly parallel to the first section 152. The adjustable strut 158 is secured at one end to the second section 154, and releasably attached to the first section 152. A releasable locking pin 182 is located on the first section 152 and can interact with various similarly sized apertures 184 located on the adjustable strut 158. The strut 158 may be attached by nut and bolt or by any other conventional attachment means.

Still referring to FIG. 10, the second locking mechanism 160 is located on the first section 152. A handle 186 located on the corner brace 178 interacts with the second locking mechanism 160. When the locking mechanism 160 is latched on the handle 186, the second section 154 cannot pivot independently from the first section 152, but can still pivot about the vertical axis of the U-shaped frame 30 as in the first embodiment. When unlatched, the second section 154 and the toolbox 22 can pivot relative to the first section 44 and pivot independently with respect to the U-shaped frame 30. This adds a second degree of freedom for the hinge plate 150, which is evidenced in FIG. 11.

FIG. 11 details the two degrees of freedom for the hinge plate 150. When the second section 154 is not connected to the first section 152, the hinge plate 150 has two degrees of motion relative to the U-shaped frame 30. The second section 154 and the toolbox 22 can pivot clear of the vehicle bed 26, around to the outside of the first sidewall 36. The strut 158 allows the hinge plate 150 to be held in this deployed position. This provides complete access to the vehicle bed 26. This arrangement is especially useful when loading or unloading drywall or other similar sheet material 39 from the vehicle 24 (see FIGS. 1 and 2).

It should be noted that the configuration for support of the toolbox 22 formed by either the hinge plate 50 of the first embodiment 20 or the second section 150 of the second embodiment 100 is not decisive to the present invention. Support for the toolbox 22, or another container, could consist of an elevated rectangular shape that the toolbox 22 would sit on, or even a cage-like design that the toolbox would slide in and out of. Provided that sufficient support is available for the toolbox 22 in a manner that will not interfere with other components of the present invention, any configuration is acceptable.

For security and safety reasons, the hinge assembly 40 may be locked in place, securing the U-shaped frame 30 to the hinge plate 50. As can be seen most clearly in FIGS. 2,3 and 8-10, an opening 80 is located on the top of hinge pin 42. The opening is arranged to receive either a bolt 82 (see FIG. 9) or a padlock 84 (see FIG. 3) or other similar locking device. A nut 86 may be threaded onto the bolt 82 to secure the bolt 82 in place. Locking the assembly prevents unwanted removal of the hinge pin 42, while not interfering with the pivotability of the assembly.

Also, while the bracket assembly 100 is shown to pivot on the passenger's side of the vehicle and latch on the driver's side of the vehicle, it is conceivable that the bracket may be slightly modified to pivot on the driver's side and latch on the passenger's side and still remain with the scope of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A bracket assembly for pivotally supporting a container at the rear of a vehicle bed, said vehicle bed having a pair of upstanding, oppositely disposed sidewalls, said bracket assembly comprising:
a hinged support member including a first hinge plate and a second hinge plate rotatably connected by a hinge pin,
said first hinge plate being attached to one of said sidewalls,
said second hinge plate providing support means for said container; and
latching means for detachably attaching said support means to the other of said sidewalls.

2. The bracket assembly according to claim 1 wherein said second hinge plate and said support means are allowed to pivot freely outwardly of the interior of the vehicle bed.

3. The bracket assembly according to claim 1 wherein said support means and said container are elevated with respect to the vehicle bed.

4. The bracket assembly according to claim 1 wherein said one of said hinge plates and said latching means are rigidly connected.

5. The bracket assembly according to claim 2 further comprising brace means, said brace means allowing said hinged support member to be secured in a position free of the interior of the vehicle bed.

6. The bracket assembly according to claim 1 further comprising means for securing said first hinge plate to said second hinge plate.

7. A bracket assembly for pivotally supporting a container at the rear of a vehicle bed, said vehicle bed having a pair of upstanding, oppositely disposed sidewalls, said bracket assembly comprising:
a first hinged support member including a first hinged plate and a second hinge plate, said first hinge plate and said second hinged plate rotatably connected by a first hinge pin,
said first hinge plate being attached to one of said sidewalls;
a second hinged support member, said second hinged support member including said second hinge plate and a third hinge plate, said second and said third hinge plate rotatably connected by a second hinge pin,
said third hinge plate further providing support means for said container; and
latching means for detachably attaching said support means to the other of said sidewalls.

8. The bracket assembly according to claim 7 wherein said first hinged support member may pivot freely outwardly of the interior of the vehicle bed.

9. The bracket assembly according to claim 7 wherein said support means and said container are elevated with respect to the vehicle bed.

10. The bracket assembly according to claim 7 wherein said first of said hinge plates and said latching means are rigidly connected.

11. The bracket assembly according to claim 8 wherein said second hinges support member is positioned to pivot said third hinge plate around said side wall to which said first hinged support member is attached.

12. The bracket assembly according to claim 7 further comprising fastening means, said fastening means allowing said second hinge plate and said third hinge plate to be removably secured together.

13. The bracket assembly according to claim 11 further comprising brace means, said brace means allowing said hinged support member to be secured in a position free of the interior of the vehicle bed.

14. The bracket assembly according to claim 7 further comprising means for securing said first hinge plate to said second hinge plate.

15. A brace structure for securely propping open a hinge plate on a hinged device of a vehicle, said brace structure comprising:
a rod having at least two continuous portions bent angularly relative to one another, said rod being rotatably connected to said hinge plate,
receiving means for receiving one of said bent portions of said rod when said hinged plate has been moved to an open position.
